(19) United States
(12) Patent Application Publication
(10) Pub. No.: US 2014/0162704 A1
(43) Pub. Date: Jun. 12, 2014

(54) METHOD OF DETERMINING POSITION OF TERMINAL IN COMMUNICATION SYSTEM USING MULTIPLE BEAMS

(71) Applicant: ELECTRONICS AND TELECOMMUNICATIONS RESEARCH INSTITUTE, Daejeon (KR)

(72) Inventors: Eun Young CHOI, Daejeon (KR); Moon Sik LEE, Daejeon (KR); Young Seog SONG, Daejeon (KR); Jun Hwan LEE, Seoul (KR); Seung Eun HONG, Daejeon (KR)

(73) Assignee: ELECTRONICS AND TELECOMMUNICATIONS RESEARCH INSTITUTE, Daejeon (KR)

(21) Appl. No.: 14/098,768

(22) Filed: Dec. 6, 2013

(30) Foreign Application Priority Data
Dec. 6, 2012 (KR) 10-2012-0140904

(51) Int. Cl. H04W 4/02

(52) U.S. Cl. CPC H04W 4/02
USPC 455/456.6

(57) ABSTRACT

A method of determining a position of a terminal in a communication system using multiple beams is provided. The method includes receiving a first beam from a first point, receiving a second beam from a second point, and determining a position of the terminal by use of information about the first beam and information about the second beam, so that in a case in which two or more effective beams are received in a system using multiple beams, the position of the terminal is determined by use of the angle of a beam, and information about coordinates of departure of a beam and/or coordinates of final arrival of a beam without using a positioning device, such as GPS.

### CLAIM FOR PRIORITY

This application claims priority to Korean Patent Application No. 10-2012-0140904 filed on Dec. 6, 2012 in the Korean Intellectual Property Office (KIPO), the entire contents of which are hereby incorporated by reference.

### BACKGROUND

1. Technical Field

Example embodiments of the present invention relate in general to the field of a positioning method of a terminal, and more particularly, to a method of obtaining position information of a terminal by use of information about a beam received by the terminal in a system of servicing using multiple beams.

2. Related Art

A positioning technique to identify the position of a terminal in a mobile communication system include a network-based positioning using a base station reception signal of a communication network and a terminal-based positioning to estimate the position by use of a global positioning system (GPS) receiver of a terminal.

The terminal-based positioning requires to have a GPS in a terminal, and thus increases the cost of manufacturing when compared to the network-based positioning, while the network-based positioning is achieved in a manner to estimate the position of a terminal in a network using the direction and time of signals incoming to the terminal and thus has a lower accuracy when compared to the terminal-based positioning.

As for the network-based positioning, a Cell-ID positioning for identifying the position of a terminal by use of a Cell ID of a base station, an Enhanced Cell ID positioning having Cell ID information and distance information between a base station and a terminal added, an angle of arrival (AOA) positioning using the angle of a signal being received by three base stations, a time of arrival (TOA) positioning using the difference in arrival time of a signal between a service base station and nearby base stations, and a time difference of arrival (TDOA) scheme measuring and using a signal delay of a service base station and nearby base stations.

The terminal-based positioning is not available for use in a place having difficulty in GPS reception, such as inside a building or in a basement, and the network-based positioning is inaccurate in case of only using a Cell ID and thus the position is determined only using information of a plurality of base stations.

### SUMMARY

Accordingly, example embodiments of the present invention are provided to substantially obviate one or more problems due to limitations and disadvantages of the related art.

Example embodiments of the present invention provide a method of determining a position of a terminal for performing a terminal position determining by receiving beams transmitted from two or more transmission points and using information included in the beams in a system using multiple beams, and more particularly, provide a method of operating a terminal for performing the terminal position determining method, a method of operating a position determining server for performing the terminal position determining method, and a method of operating transmission points for performing the terminal position determining method.

In some example embodiments, a method of operating a terminal for positioning of a terminal includes receiving a first beam from a first point, receiving a second beam from a second point, and determining a position of the terminal by use of information about the first beam and information about the second beam.

Each of the first point and the second point may represent at least one of a base station, a femtocell, a relay, and a terminal.

The information about the first beam may include at least one of an angle of the first beam with respect to a predetermined direction of the first point and coordinates of final arrival of the first beam, and the information about the second beam may include at least one of an angle of the second beam with respect to a predetermined direction of the second point and coordinates of final arrival of the second beam. Each of the angle of the first beam and the angle of the second beam may be a two dimensional angle or a three dimensional angle. Each of the coordinates of final arrival of the first beam and the coordinates of final arrival of the second beam may represent two dimensional coordinates or three dimensional coordinates.

Each of the information about the first beam and the information about the second beam may be received as a beam identifier.

In the determining of the position of the terminal, the terminal may receive position information of the first point and position information of the second point from a network, calculate coordinates of an intersection of the first beam and the second beam based on the position information of the first point and the position information of the second point, and determine the position of the terminal based on the coordinates of the intersection.

In the determining of the position of the terminal, the terminal may transmit the information about the first beam and the information about the second beam to a network, receive coordinates of an intersection of the first beam and the second beam that is calculated based on position information of the first point and position information of the second point from the network, and determine the position of the terminal based on the coordinates of the intersection.

The information about the first beam additionally may include coordinates of departure of the first beam, and the information about the second beam additionally may include coordinates of departure of the second beam. In the determining of the position of the terminal, the terminal may calculate coordinates of an intersection of the first beam and the second beam based on the coordinates of departure of the first beam and the coordinates of departure of the second beam, and determine the position of the terminal based on the coordinates of the intersection.

In other example embodiments, a method of operating a position determining server for position determining of a terminal includes receiving information about a first beam and information about a second beam that are received by a terminal, and providing the terminal with position information of a first point which generates the first beam and position information of a second point which generates the second beam, based on the information about the first beam and the information about the second beam, or determining the position of the terminal based on the information about the first beam, the information about the second beam, the position information of the first point, and the position information of the second point.

Each of the first point and the second point may represent at least one of a base station, a femtocell, a relay, and a terminal.

The information about the first beam may include at least one of an angle of the first beam with respect to a predetermined direction of the first point and coordinates of final arrival of the first beam, and the information about the second beam may include at least one of an angle of the second beam with respect to a predetermined direction of the second point and coordinates of final arrival of the second beam. Each of the angle of the first beam and the angle of the second beam may be a two dimensional angle or a three dimensional angle. Each of the coordinates of final arrival of the first beam and the coordinates of final arrival of the second beam may represent two dimensional coordinates or three dimensional coordinates.

In the determining of the position of the terminal, coordinates of an intersection of the first beam and the second beam is calculated based on the information about the first beam and the information about the second beam, which are received from the terminal, and the position information of the first point and the position information of the second point, and the position of the terminal is determined based on the coordinates of the intersection.

In still other example embodiments, a method of operating a transmission point for position determining of a terminal include generating multiple beams configured to transmit information about each beam therein, wherein the information about the beam may include at least one of information about an angle with respect to a predetermined direction of a certain beam and coordinates of final arrival of the certain beam.

The information about the beam may additionally include coordinates of departure of the certain beam.

The information about the angle may be a two dimensional angle or a three dimensional angle.

The coordinates of final arrival may represent two dimensional coordinates or three dimensional coordinates.

The transmission point may represent at least one of a base station, a femtocell, a relay, and a terminal.

As is apparent from the position determining method in accordance with the present invention, the terminal position determining is achieved by receiving two or more effective beams in a system using multiple beams and using the angle of a beam, and the departure coordinate information and/or final coordinate information of the beams that are included in the beams. In addition, even if the number of effective beams transmitted from the transmission points, such as a base station and a relay, is one or less, a nearby terminal may be used as a transmission point for the positioning.

That is, when the position determining method in accordance with the present invention is used, if two or more effective beams are received in a system using multiple beams, the position of a terminal may be determined without using a positioning device, such as GPS.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a concept of a method of determining the position of a terminal in a multiple beam system in accordance with the present invention.

FIG. 2 is a conceptual diagram illustrating a concept of an effective beam in the terminal position determining method in accordance with the present invention.

FIG. 3 is a conceptual diagram illustrating a method of performing position determining of a terminal in the terminal position determining method in accordance with the present invention in a case in which the number of effective beams is one.

FIG. 4 is a conceptual diagram illustrating an example embodiment of constructing MAP information that is used in the terminal position determining method in accordance with the present invention.

FIG. 5 is a conceptual diagram illustrating an example embodiment of a two dimensional position determining method in accordance with the present invention.

FIG. 6 is a conceptual diagram illustrating another example embodiment of a two dimensional position determining method in accordance with the present invention.

FIG. 7 is a conceptual diagram illustrating an example embodiment of a three dimensional position determining method in accordance with the present invention.

FIG. 8 is a conceptual diagram illustrating another example embodiment of a three dimensional position determining method in accordance with the present invention.

FIG. 9 is a conceptual diagram illustrating an additional configuration of a beam identifier in the terminal position determining method in accordance with the present invention.

FIG. 10 is a flowchart showing a method of operating a terminal for performing the terminal position determining method in accordance with the present invention.

FIG. 11 is a flowchart showing a method of operating a position determining server for performing the terminal position determining method in accordance with the present invention.

### DESCRIPTION OF EXAMPLE EMBODIMENTS

Example embodiments of the present invention are disclosed herein. However, specific structural and functional details disclosed herein are merely representative for the purposes of describing example embodiments of the present invention, and thus example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in reverse order, depending upon the functionality/acts involved.

A ‘terminal’ used in the present application may be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit, a mobile node, a mobile, or other terms. Various example embodiments of the terminal may include a cellular phone, a smartphone having a wireless communication function, a personal digital assistant (PDA) having a wireless communication function, a wireless modem, a portable computer having a wireless communication function, a photographing device, such as a digital camera, having a wireless communication function, a gaming device having a wireless communication function, a music storage and playback home appliance having a wireless communication function, and an Internet home appliance capable of a wireless Internet access and browsing, and a portable unit or terminal incorporating the functions, but are not limited thereto.

A ‘base station’ used in this application represents a point that is in general fixed or moved while communicating with a terminal, and is a term collectively representing a base station, a Node-B, an eNode-B, a base transceiver system (BTS), an access point, a relay, and a femtocell.

Hereinafter, example embodiments of the present invention will be described with reference to accompanied drawings. In the following description, the same reference numerals will be assigned to the parts of the present embodiments that are identical to those according to the previous embodiment, and details of parts will be omitted in order to avoid redundancy.

The present invention relates to a method of using information about multiple beams to obtain position information of a terminal. That is, the present invention relates to a method of determining the position of a terminal by calculating the coordinates of an intersection of lines passing through transmission points and the terminal, by use of beam information received from multiple transmission points. Here, ‘the transmission point’ is used as a collective term representing a macro base station, a picocell, a femtocell, a relay, a distributed antenna, and a remote radio head (RRH) that may generate beams.

If the position information of a terminal is known, various services may be supported, an optimum path, connected from a central base station via a relay or directly connected from a central base station, is rapidly found, and a handover point of time is estimated, so that a candidate region having a chance of a handover is predicated, which enables a rapid handover.

An Outline of Position Determining Method in Accordance with the Present Invention

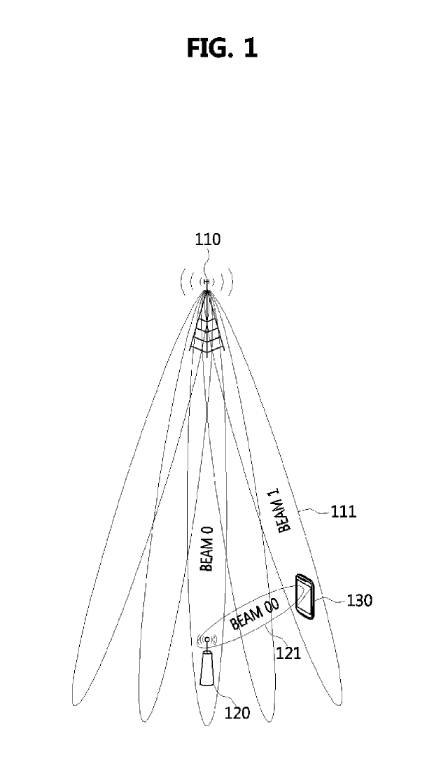

FIG. 1 is a conceptual diagram illustrating a concept of a method of determining the position of a terminal in a multiple beam system in accordance with the present invention.

Referring to FIG. 1, a terminal 130 receives a beam 111 and a beam 121 from a base station 110 and a relay 120, respectively. In this case, the position of the terminal 130 may be determined by calculating the intersection of a line passing through the base station 110 and the terminal 130 and a line passing through the relay 120 and the terminal 130.

In this case, in order to determine the intersection, position information of the base station 110 and position information of the relay 120 are required. In order to find the position information, basically, information about a region managed by a central base station is required. That is, the positions of transmission points, for example, a relay, existing in a region managed by a central base station need to be identified.

The central base station estimates the position of the terminal by storing and managing information in the form of MAP information, and the MAP information may be constructed as two dimensional information and three dimensional information by dividing a region managed. If the MAP information is well constructed, the position may be identified by use of a small amount of information. The central base station may obtain the position by making information into an algorithm without using the MAP information. In this case, the position may be expressed in an equation to obtain two lines each passing through two coordinates and obtain an intersection of the two lines.

Here, the transmission points such as the base station 110 and the relay 120 each divide a service region and provide services in the form of an independent beam. In a case in which the base station 110 obtains two or more pieces of information from a beam generated by the base station 110 and beams generated by the relay 120, the base station 110 may identify the position of the terminal 130.

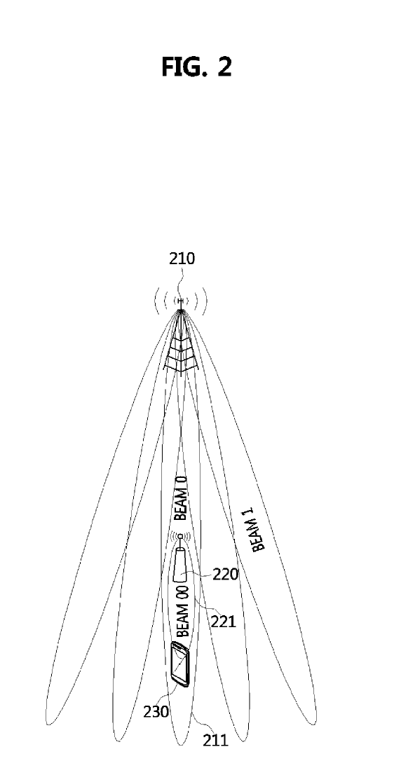

FIG. 2 is a conceptual diagram illustrating a concept of an effective beam in the terminal position determining method in accordance with the present invention.

Referring to FIG. 2, a base station 210 and a relay 220 generate a beam 211 and a beam 221, respectively, that have the same direction each other for a terminal 230. In the case in which the two beams 211 and 221 have the same direction (angle), only the information about a close beam is effective. That is, even though a distant beam is usable, when the close beam and the distant beam are introduced in the same direction, the information about the close beam is stably received, so that the number of effective reception beams is one in practice.

Accordingly, in a case in which the number of effective beams is one as shown in FIG. 2, an additional method is considered.

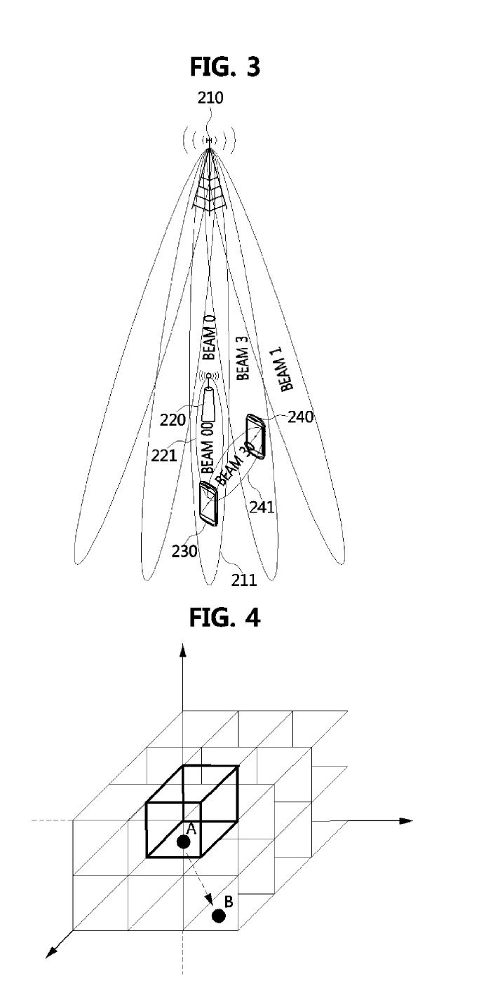

FIG. 3 is a conceptual diagram illustrating a method of performing position determining of a terminal in the terminal position determining method in accordance with the present invention in a case in which the number of effective beams is one.

In the case in which two beams have the same direction (angle) as shown in FIG. 2, only the information about a close beam is effective, and additional beam information is necessary in order to precisely identify the position of the terminal 230.

Accordingly, the position determining in accordance with the present invention is configured to determine the position of the terminal 230 by use of information about a beam 241 generated by another terminal 240, the position of which is identified. In this case, the terminal 230 may be configured to directly request information from the nearby terminal 240 (that is, request the terminal 240 to generate the beam 241 for the terminal 230). Alternatively, when the terminal 230 requests information from the base station 210, the base station 210 makes a decision and allows the terminal 240 to generate the beam 241 and provide the terminal 230 with information about the beam 241.

In order to implement the method described above with reference to FIGS. 1 to 3, a beam, which is generated by transmission points or nearby terminals, received by the terminal needs to include information capable of specifying the beam.

In this case, in order to specify the beam, information about an angle of a beam with respect to a predetermined direction of a transmission point generating the beam or information about coordinates of final arrival of the beam are sent in the beam from the transmission points. The information about an angle or information about the coordinates of final arrival may be transmitted as an identifier of the beam, or may be transmitted through a control channel or data channel of the beam rather than as the beam identifier, in order to more specify the beam information. Each beam in a system operating multiple beams may transmit information to terminals within a range corresponding to the beam by use of independent resources or a wireless channel, in particular, in a multiple beam operation system operating in a super high frequency (SHF) band or an extremely high frequency (EHF) band.

The beam information (for example, the beam information transmitted as a beam identifier) is transmitted to the terminal so as to be known in an synchronization process, as when a cell ID, for example, a physical cell identifier (PCI) is extracted from a primary synchronization signal (PSS)/a secondary synchronization signal (SSS) that is used for synchronization in a conventional long term evolution (LTE).

The position determining of a terminal, in a case in which two or more pieces of effective beam information are obtained by the terminal, may be achieved using two methods.

In the first method, the terminal may have MAP information to find out its own position as certain position information (information about designated position or coordinates), and transmit its own position to a base station (or an entity of a network other than a base station). However, in this case, the base station needs to transmit MAP information to the terminal, and if the terminal makes a handover to another base station, the terminal needs to receive MAP information from the other base station.

In the second method, the terminal transmits received beam information to the base station. The terminal transmits a received beam identifier to the base station (or an entity of a network other than a base station) such that the base station calculates the position of the terminal using MAP information. In this case, the base station (or an entity of a network other than a base station) needs to process a great amount of information received from each terminal.

Accordingly, which of the first method and the second method is used needs to be determined in consideration of a form of constructed MAP information and a terminal-to-base station signaling overhead depending on the type and size of the beam information.

Hereinafter, detailed description of example embodiments in a case when the information included in a beam is the angle information or final arrival coordinates of the beam will be made with respect to a two dimensional position determining and a three dimensional position determining.

FIG. 4 is a conceptual diagram illustrating an example embodiment of constructing MAP information that is used in the terminal position determining method in accordance with the present invention.

The MAP information may include position information of transmission points, and may be constructed as two dimensional MAP information or three dimensional MAP information as shown in FIG. 4. The two dimensional MAP information represents the position viewed in an aspect of a plane, and the three dimensional MAP information represents the position further considering the height. For example, the MAP information may be constructed by representing a region serviced by a base station in the form of coordinates, while including two dimensional coordinates or three dimensional coordinates of transmission points existing in a serviced region.

In a case in which the MAP information is constructed in a three dimension, the size of the MAP information is significantly increased. Accordingly, there is a need for efficiently constructing the MAP information, and also a need for an algorithm (operation) for position determining.

The MAP information may be constructed while including coordinate information of transmission points that are represented in a coordinate system incorporating all ranges serviced by a single base station, but in this case, the amount of data is increased. Accordingly, in order to reduce the amount of data of MAP information, the serviced regions are divided into multiple sub-MAPs, coordinates are assigned to the transmission points on the sub-MAP basis by use of the coordinate systems of the respective sub-MAPs, and the coordinates at the respective sub-MAPs are converted into the entire coordinate system.

As illustrated in FIG. 4, a region having a terminal, the position of which needs to be determined, is moved to coordinates of the center (A) for determination, and then the region returns to its original position (B). In this manner, the size of the MAP information is optimized.

Hereinafter, a method of determining a two dimensional position of a terminal in accordance with the present invention will be described.

A Two Dimensional Position Determining Method

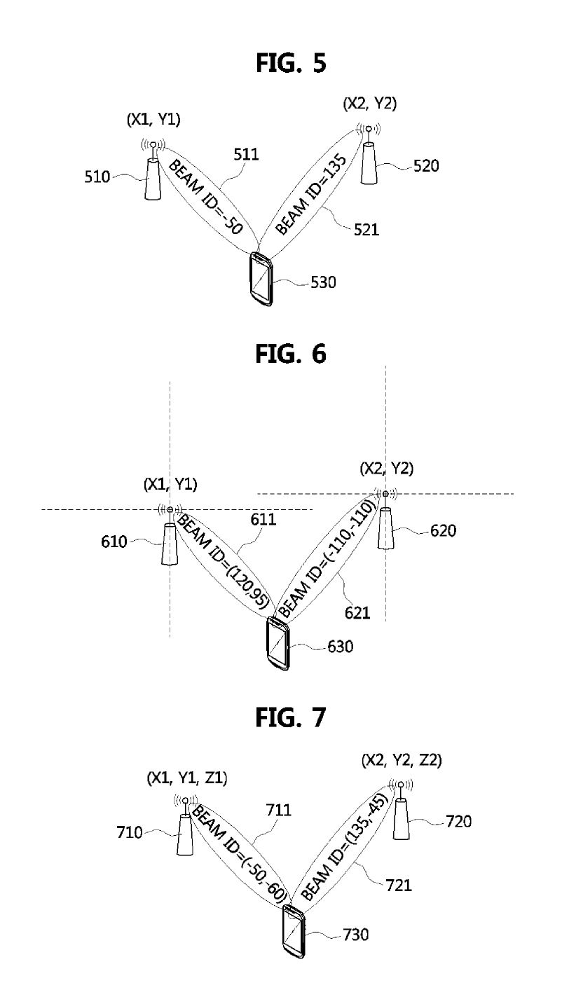

FIG. 5 is a conceptual diagram illustrating an example embodiment of a two dimensional position determining method in accordance with the present invention

Referring to FIG. 5, information about a beam may include angle information about the beam. For example, a terminal 530 receives angle information about beams from a first transmission point 510 and a second transmission point 520, positions of which are fixed (known).

As one example, FIG. 5 illustrates a case in which a beam 511 generated from the first transmission point 510, the position (x1, y1) of which is known, includes angle information (−50) of the beam 511, and a beam 521 generated from the second transmission point 520, the position (x2, y2) of which is known, includes angle information (135) of the beam 521. Here, the angle information is provided as information about an angle of a beam with respect to a predetermined direction of a transmission point (with respect to +x axis direction in FIG. 5 that is assumed as an angle of 0 degree).

If angle information of a beam is sent in the beam as information about the beam (for example, as an identifier of the beam), by transmission points, the terminals may roughly identify angle information of the beam from the received beam information, and additionally estimate the accurate angle of the beam from reception data. In the case in which angle information is used as a beam identifier, the beam identifier may be reused.

As another example, beam information may include coordinates of final arrival of a beam. The distance of final arrival of a beam may vary with wireless environments. Accordingly, the coordinates of final arrival of a beam may be estimated based on a path loss and a transmission power of beam. However, the coordinates of final arrival of a beam included as beam information in accordance with the present invention does not need to indicate accurate coordinates of final arrival of a beam, and may only serve to determine a line passing through a transmission point and arrival coordinates for obtaining an intersection of two or more beams.

FIG. 6 is a conceptual diagram illustrating another example embodiment of a two dimensional position determining method in accordance with the present invention.

Referring to FIG. 6, a terminal 630 receives information about coordinates of arrival of beams from a first transmission point 610 and a second transmission point 620, positions of which are fixed (known).

For example, FIG. 6 illustrates a case in which a beam 611 generated from the first transmission point 610, the position (x1, y1) of which is known, includes coordinates of (120, 95) of final arrival of the beam 611, and a beam 621 generated from the second transmission point 620, the position (x2, y2) of which is known, includes coordinates (−110, −110) of final arrival of the beam 621. Here, the coordinates of final arrival of a beam are provided as relative coordinate values on the x-y plane when the position of each transmission point is assumed as (0, 0). Here, the coordinates of final arrival of a beam may be implemented using a Cartesian coordinate system, as illustrated in FIG. 6, or a polar coordinate system.

FIG. 6 represents a case in which final coordinates, reachable by a beam transmitted by a transmission point, are sent in beam information along with the beam. In this case, the coordinates may be absolute coordinates, but as shown in FIG. 6, in order to efficiently express information, relative coordinates obtained by setting a point of departure (a transmission point) as zero may be used. Even in a case in which relative coordinates are used as the final coordinates, since the coordinates of transmission points (coordinates of departure of a beam) have been already stored in the MAP information, the final coordinates of the beam is obtained in the original form using the information about coordinate of departure. Since coordinates are set based on a relay, representing a fixed point, efficient representation of coordinates is achieved with a small amount of information when compared to using the entire base station region as a coordinate space. The terminal transmits the received beam information to the base station, and the base station identifies the final position.

Hereinafter, a method of determining a three dimensional position of a terminal in accordance with the present invention will be described.

A Three Dimensional Position Determining Method

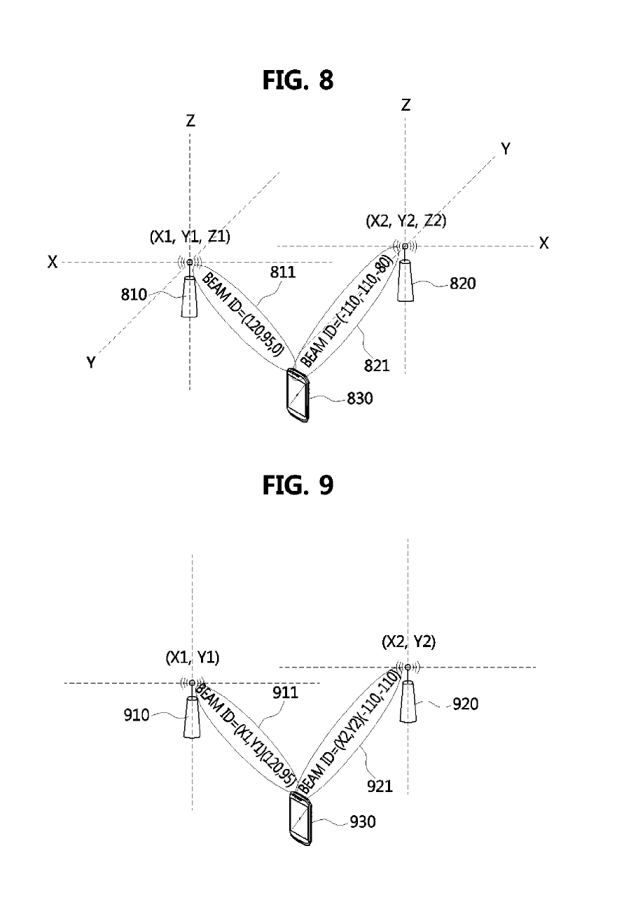

FIG. 7 is a conceptual diagram illustrating an example embodiment of a three dimensional position determining method in accordance with the present invention, and FIG. 8 is a conceptual diagram illustrating another example embodiment of a three dimensional position determining method in accordance with the present invention.

Similar to the two dimensional terminal position determining method, a method of determining the position of a terminal in a three dimension is also achieved by finding out the position at which two beams intersect each other. For the three dimensional position determining, when angle information is used as beam information, the beam information is provided to include information about a horizontal angle and information about a vertical angle (that is, including a three dimensional angle), and when coordinates of arrival of a beam are used as the beam information, three dimensional coordinates (x, y, z) are used.

FIG. 7 illustrates a case in which a beam 711 generated from a first transmission point 710, the position (x1, y1, z1) of which is known, includes angle information (−50, −60) of the beam 711, and a beam 721 generated from a second transmission point 720, the position (x2, y2, z2) of which is known, includes angle information (135, −45) of the beam 721. Here, the angle information is provided as information about an angle of a beam with respect to a predetermined direction of a transmission point (a horizontal angle with respect to +x axis direction in FIG. 6 that is assumed as an angle of 0 degree, and a vertical angle with respect to the x-y plane in FIG. 6 that is assumed as an angle of 0 degree).

FIG. 8 illustrates a case in which a beam 811 generated from a first transmission point 810, the position (x1, y1, z1) of which is known, includes coordinates (120, 95, 0) of final arrival of the beam 811, and a beam 821 generated from a second transmission point 820, the position (x2, y2, z2) of which is known, includes coordinates (−110, −110, −80) of final arrival of the beam 821. Here, the coordinates of final arrival of a beam are provided as relative coordinate values in a xyz-three dimensional space when the position of each transmission point is assumed as (0, 0, 0). Here, the coordinates of final arrival of a beam may be implemented using a Cartesian coordinate system, as illustrated in FIG. 8, or a polar coordinate system.

In a case in which the angle information is included as the beam information, when two beams are incoming at the same angles, only one of the two beams is effective (as described in FIG. 2). In this case, another beam information needs to be used to precisely determine the position (as described in FIG. 3). In a case in which only one effective beam is obtained from a base station or a relay, a virtual position beam is used. To this end, a terminal, the position of which is known, operates in the same way as a relay, as described above, in which a terminal transmitting a virtual position identification beam delivers information about its own position to a network to help the network to identify the current position of the terminal.

Meanwhile, in a case in which the coordinates of final arrival of a beam are used, a minute representation of the angle may be possible. If coordinates of final arrival of two beams included in beam information are the same, whether or not the two beams have the same angles is not instantly determined, and by only checking the coordinates of the transmission points, the effectiveness of beam information is determined.

The process of identifying, by a terminal or a base station, the position of the terminal using coordinate information or angle information of beams is the same as connecting coordinates of two points to each other using a string and obtaining a point at which the string intersects a string connecting coordinates of other two points to each other. That is, when a slope and a y-intercept of a liner expression are considered, if two points, passed by a line, are known or one point, passed by a line, and a slope of the line are known, coordinates, passed by the one string, are determined, and coordinates of the remaining string are also obtained in the same way as the one string, for obtaining a point at which the two linear expressions meet.

Meanwhile, the above-described examples of position determining have been illustrated in that the position information of the transmission points is included in the network, and is provided to the terminal such that the terminal determines the position, or beam information received by the terminal is transmitted to the network such that the network determines the position of the terminal. However, transmitting position information of transmission points (that is, the coordinates of departure of a beam) in beam information may be possible.

FIG. 9 is a conceptual diagram illustrating an additional configuration of a beam identifier in the terminal position determining method in accordance with the present invention.

FIG. 9 illustrates a case in which a terminal 930 receives a beam 911 that is transmitted from a first transmission point 910 while including coordinates (120, 95) of final arrival and coordinates (x1, y1) of departure of the beam 911(representing the coordinates of the first transmission point 910) as beam information, and receives a beam 921 that is transmitted from a second transmission point 920 while including coordinates (−110, −110) of final arrival and coordinates (x2, y2) of departure of the beam 921 (representing the coordinates of the second transmission point 920) as beam information.

Since the positions of the transmission points with respect to a region serviced by a single base station are fixed, the coordinates of departure of the beam do not need to be transmitted, but in a case in which beams of transmission points included in a nearby base station are used, coordinates of departure of the beams are difficult to determine. Position information of transmission points managed by each base station may be exchanged and known by use of interface between base stations, but transmitting the coordinates of departure of the beams (position information of the transmission points) in the beams enables the terminal to easily process the beam.

In this case, the terminal may identify its own position for itself, and if the terminal transmits received beam information to a base station servicing the terminal, the service base station may track the position of the terminal without beam information of a nearby base station.

Such beam information may be combined in various forms, for example, angle information, beam departure coordinate information+angle information, beam arrival coordinate information, and beam departure+arrival coordinate information. Since it is difficult to represent the arrival coordinates for a broad area, the arrival coordinates may be constructed as relative coordinates for the amount of information of representation, by viewing the coordinates of departure as a zero point.

In this manner, the base station or the terminal may identify the position of the terminal by matching the beam information to MAP information included in the base station and the terminal. Alternatively, in a case in which two effective values are obtained from the departure coordinate information, the angle, and the arrival coordinates, the position may be obtained by use of an equation. If only using the beam identifier is not sufficient to represent information required to identify the position, the information may be sent in a data symbol.

A Method of Operating a Terminal for Performing Position Determining in Accordance with Present Invention

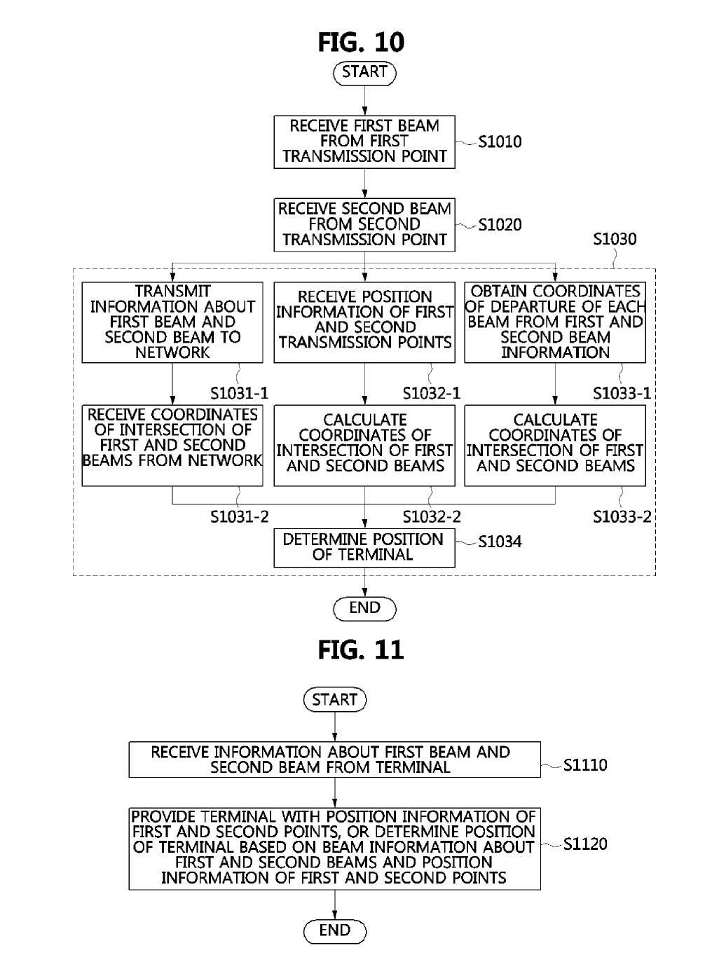

FIG. 10 is a flowchart showing a method of operating a terminal for performing the terminal position determining method in accordance with the present invention.

Referring to FIG. 10, the method of operating the terminal includes receiving a first beam from a first point (S1010), receiving a second beam from a second point (S1020), and determining the position of the terminal by use of information included in the first beam and the second beam (S1030).

In operation S1010 and operation S1020, the terminal receives beams from two or more transmission points (the first transmission point and the second transmission point), respectively. The transmission points to generate the beams received by the terminal may be at least one of a base station, a femtocell, a relay, and a terminal. In this case, the condition in which a terminal receives a beam from another terminal represents a case in which the number of effective beams receivable by a terminal is 1, or the quality of beams is poor even if the number of effective beams is 2 or more and assistance of a nearby terminal is required. The description thereof has been described above in FIGS. 2 and 3.

Each of the beams may include angle information of the beam with respect to a predetermined direction of a point corresponding to the beam, or coordinates of final arrival of each beam. In this case, the angle information and the coordinates of final arrival of the beam may be provided in a two dimension or a three dimension.

The above-described angle information and final arrival coordinate information of the beam may be sent while being included in the beam as beam identifiers. In addition, each beam may be received while including coordinates of departure of the each beam. In a strict sense, the coordinates of departure of the beam are coordinates of a transmission antenna of a transmission point, and represent the position of the transmission point.

Finally, in operation S1030, the terminal determines the position of the terminal by use of the information included in the first beam and the second beam.

Operation S1030 may be classified into a case 1) in which the terminal transmits the received beam information to the network such that the network determines the position of the terminal, a case 2) in which the terminal receives position information of transmission points from the network such that the terminal determines the position of the terminal, and a case 3) in which the departure coordinates of the beam are sent in the beam identifier such that the terminal determines the position of the terminal without exchanging information with the network.

Referring to FIG. 10, the above three cases in operation S1030 are illustrated as a procedure S1031-1, S1031-2, and S1034, a procedure S1032-1, S1032-2, and S1034, and a procedure S1033-1, S1033-2, and S1034, respectively.

In the procedure S1031-1, S1031-2, and S1034 corresponding to the above-described case 1), the terminal transmits information included in the first beam and the second beam to the network (S1031-1), receives coordinates of an intersection between the first beam and the second beam calculated based on position information of the first point and position information of the second point from the network (S1031-2), and determines the position of the terminal based on the coordinates of the intersection (S1034).

In the procedure S1032-1, S1032-2, and S1034 corresponding to the above-described case 2), the terminal receives position information of the first point and position information of the second point from the network (S1032-1), calculates coordinates of an intersection of the first beam and the second beam based on each position information (S1032-2), and determines the position of the terminal based on the coordinates of the intersection (S1034).

In the procedure S1033-1, S1033-2, and S1034 corresponding to the above-described case 3), the terminal obtains departure coordinates of the first beam and departure coordinates of the second beam using received beam information (S1033-1), calculates coordinates of an intersection between the first beam and the second beam based on the departure coordinates of the first beam, the departure coordinates of the second beam, and the beam information (S1033-2), and determines the position of the terminal based on the coordinates of the intersection (S1034). In this case, each of the beams received by the terminal needs to include information about departure coordinates of the each beam.

A Method of Operating a Network for Performing Position Determining in Accordance with the Present Invention

The method of operating the network may be classified into a method 1) of operating a transmission point configured to generate a beam, and a method 2) of operating an entity for receiving beam information, which is received by a terminal, from the terminal and determining the position of the terminal based on stored position information of points.

In general, the entity to determine the position of the terminal may also serve as a transmission point. A macro base station generally serves as a transmission point and an entity that determines the position of a terminal. However, depending on other examples, various entities rather than a macro base station may be configured to determine the position of the terminal. For example, the entity to determine the position of a terminal may be a separate position determining server, rather than a transmission point, existing in a core network. The entity to determine the position of a terminal needs to collectively store position information of various transmission points existing in the network as MAP information described above. Accordingly, in order to collectively manage position information about transmission points in a consistent manner, the presence of a separate entity for position determination is preferable rather than having a certain transmission point performing the position determination of a terminal.

The following description will be made while referring an entity to perform the position determination of a terminal in a network as a position determining server. Since the position determining server may serve as a base station (or a transmission point), but may operate independent of a transmission point, the operation of the position determining server will be described separately from the operation of the transmission point.

FIG. 11 is a flowchart showing a method of operating a position determining server for performing the terminal position determining method in accordance with the present invention.

Referring to FIG. 11, the method of operating the position determining server includes receiving information about a first beam and information about a second beam, which are received by a terminal, from the terminal (S1110), providing the terminal with position information of a first point that generates the first beam and position information of a second point that generates the second beam based on the information about the first beam and the information about the second beam, or determining the position of the terminal based on the information about the first beam, the information about the second beam, the position information of the first point, and the position information of the second point (S1120).

In operation S1110, the position determining server receives information about beams, which are received by the terminal, from the terminal. In this case, the beam information may include angle information of a beam and coordinates of final arrival of a beam, and may further include coordinates of departure of a beam, as described above.

In operation S1120, the position determining sever may operate in two schemes.

In the first scheme, when information about a beam is received from a terminal, the position determining server identifies a transmission point, which has transmitted the beam, from the beam information, and provides position information about the transmission point to the terminal.

In this case, the terminal calculates an intersection of beams by use of the position information of the transmission points, which is provided by the position determining server, and the beam information included in the terminal, and determines the position based on the calculated intersection. That is, the first scheme corresponds to the method of operating the terminal described above in the procedures S1031-1 and S1031-2 of FIG. 10.

In the second scheme, when information about a beam is received from a terminal as described in the procedures 1032-1 and 1032-2 of FIG. 10, the position determining server identifies a transmission point that has transmitted the beam from received beam information, calculates an intersection of beams by use of position information of the identified transmission points and received beam information, and determines the position of the terminal based on the calculated intersection. The position information of the terminal determined by the position determining server may be transmitted to the terminal.

That is, the difference between the first scheme and the second scheme is that the first scheme performs the calculation of the intersection between beams, which is used to determine the position of the terminal, in the terminal, while the second scheme performs the calculation of the intersection between beam, which is used to determine the position of the terminal, in the position determining server.

A method of operating a transmission point for performing the position determining of a terminal in accordance with the present invention includes generating multiple beams along which beam information corresponding to each beam is transmitted, and the beam information may include at least one of angle information of a beam with respect to a predetermined direction and coordinate information about final arrival of a beam.

In addition, the beam information may further include coordinates of departure of a beam. In addition, the angle information, the arrival coordinate information, and the departure coordinates may be provided in a two dimension or a three dimension.

The beam information described above, while serving as a beam identifier, may be transmitted through a synchronization signal, such as PSS/SSS, or may be transmitted through a control channel or a data channel of each beam. The environment that may be applied with the terminal position determining method in accordance with the present invention may correspond to a case of operating a SHF/EFH that can operate multiple of minute and fine beams based on a beam forming technique, and in this case, each beam may transmit information to terminals within a range of the beam, by use of independent resources and wireless channels.

While the example embodiments of the present invention and their advantages have been described in detail, it should be understood that various changes, substitutions, and alterations may be made herein without departing from the scope of the invention.

What is claimed is:

1. A method of operating a terminal for positioning of a terminal, the method comprising:
receiving a first beam from a first point;
receiving a second beam from a second point; and
determining a position of the terminal by use of information about the first beam and information about the second beam.

2. The method of claim 1, wherein each of the first point and the second point represents at least one of a base station, a femtocell, a relay, and a terminal.

3. The method of claim 1, wherein the information about the first beam comprises at least one of an angle of the first beam with respect to a predetermined direction of the first point and coordinates of final arrival of the first beam, and
the information about the second beam comprises at least one of an angle of the second beam with respect to a predetermined direction of the second point and coordinates of final arrival of the second beam.

4. The method of claim 3, wherein each of the angle of the first beam and the angle of the second beam is a two dimensional angle or a three dimensional angle.

5. The method of claim 3, wherein each of the coordinates of final arrival of the first beam and the coordinates of final arrival of the second beam represents two dimensional coordinates or three dimensional coordinates.

6. The method of claim 1, wherein each of the information about the first beam and the information about the second beam is received as a beam identifier.

7. The method of claim 1, wherein in the determining of the position of the terminal, the terminal receives position information of the first point and position information of the second point from a network, calculates coordinates of an intersection of the first beam and the second beam based on the position information of the first point and the position information of the second point, and determines the position of the terminal based on the coordinates of the intersection.

8. The method of claim 1, wherein in the determining of the position of the terminal, the terminal transmits the information about the first beam and the information about the second beam to a network, receives coordinates of an intersection of the first beam and the second beam that is calculated based on position information of the first point and position information of the second point from the network, and determines the position of the terminal based on the coordinates of the intersection.

9. The method of claim 3, wherein:
the information about the first beam additionally comprises coordinates of departure of the first beam, and the information about the second beam additionally comprises coordinates of departure of the second beam, and
in the determining of the position of the terminal, the terminal calculates coordinates of an intersection of the first beam and the second beam based on the coordinates of departure of the first beam and the coordinates of departure of the second beam, and determines the position of the terminal based on the coordinates of the intersection.

10. A method of operating a position determining server for position determining of a terminal, the method comprising:
receiving information about a first beam and information about a second beam that are received by a terminal; and
providing the terminal with position information of a first point which generates the first beam and position information of a second point which generates the second beam, based on the information about the first beam and the information about the second beam, or determining the position of the terminal based on the information about the first beam, the information about the second beam, the position information of the first point, and the position information of the second point.

11. The method of claim 10, wherein each of the first point and the second point represents at least one of a base station, a femtocell, a relay, and a terminal.

12. The method of claim 10, wherein:
the information about the first beam comprises at least one of an angle of the first beam with respect to a predetermined direction of the first point and coordinates of final arrival of the first beam, and
the information about the second beam comprises at least one of an angle of the second beam with respect to a predetermined direction of the second point and coordinates of final arrival of the second beam.

13. The method of claim 12, wherein each of the angle of the first beam and the angle of the second beam is a two dimensional angle or a three dimensional angle.

14. The method of claim 12, wherein each of the coordinates of final arrival of the first beam and the coordinates of final arrival of the second beam represents two dimensional coordinates or three dimensional coordinates.

15. The method of claim 11, wherein in the determining of the position of the terminal, coordinates of an intersection of the first beam and the second beam is calculated based on the information about the first beam and the information about the second beam, which are received from the terminal, and the position information of the first point and the position information of the second point, and the position of the terminal is determined based on the coordinates of the intersection.

16. A method of operating a transmission point for position determining of a terminal, the method comprising:
generating multiple beams configured to transmit information about each beam therein,
wherein the information about the beam comprises at least one of information about an angle with respect to a predetermined direction of a certain beam and coordinates of final arrival of the certain beam.

17. The method of claim 16, wherein the information about the beam additionally comprises coordinates of departure of the certain beam.

18. The method of claim 16, wherein the information about the angle is a two dimensional angle or a three dimensional angle.

19. The method of claim 16, wherein the coordinates of final arrival represents two dimensional coordinates or three dimensional coordinates.

20. The method of claim 16, wherein the transmission point represents at least one of a base station, a femtocell, a relay, and a terminal.
